(19) United States
(12) Patent Application Publication
(10) Pub. No.: US 2007/0146868 A1
(43) Pub. Date: Jun. 28, 2007

(54) Broadband antireflection coating

(75) Inventor: Koji Yamaguchi, Miyozaki-shi (JP)

Correspondence Address: OLIFF & BERRIDGE, PLC, P.O. BOX 19928, ALEXANDRIA, VA, 22320, US

(73) Assignee: EPSON TOYOCOM CORPORATION, TOKYO (JP)

(21) Appl. No.: 11/643,964

(22) Filed: Dec. 22, 2006

(30) Foreign Application Priority Data
Dec. 26, 2005 (JP) 2005-371539

(51) Int. Cl. F21V 9/04

(52) U.S. Cl. 359/359; 359/586

(57) ABSTRACT

A broadband antireflection coating formed on at least one of an incident surface or an emission surface of an optical element and reduces reflected-light quantity of incident light or emission light, includes: a structure laminating seven layers of a thin film.

### BACKGROUND OF THE INVENTION

1. Technical Field

The present invention relates to a broadband antireflection coating. More particularly, the present invention relates to a broadband antireflection coating which is formed on incident and emission surfaces of an optical element, and broadens the bandwidth of transmittance characteristics and reduces variations in the transmittance characteristics of an antireflection coating which reduces reflected-light quantity of incident light.

2.Related Art

An antireflection coating which reduces reflection of light at incident and emission surfaces is formed on incident and emission surfaces of an optical element forming optical-related devices such as lens, prisms and wavelength plates, to prevent attenuation of light quantity of incident light. JP-A-2000-199802, JP-A-2001-235602 and JP-A-2002-311209 are examples of the related arts.

FIG. 7 is a diagram showing a configuration example of an antireflection coating of related art. An antireflection coating 1 of related art shown in FIG. 7 is formed by laminating three layers of thin films on a substrate 2 which is to become an optical element, and designed to achieve a desired performance in a visible light band. The antireflection coating 1 is formed by laminating a first thin film 3, a second thin film 4 and a third thin film 5 sequentially on a surface of the substrate 2. The first thin film 3 is made of Al₂O₃ which is an intermediate refractive index material, the second thin film 4 is made of H₄ (a mixture of La and TiO₂) which is a high refractive index material manufactured by Merck & Co., Inc., and the third thin film 5 is made of MgF₂ which is a low refractive index material.

The above-described high refractive index material indicates a material which has a larger refractive index than the substrate 2, the low refractive index material indicates a material which has a smaller refractive index than the substrate 2, and the intermediate refractive index material indicates a material which has an intermediate refractive index between the high refractive index material and the low refractive index material.

Next, the concrete data of transmittance characteristics in an antireflection coating of related art will be described. FIG. 8 is a graph showing transmittance characteristics in an antireflection coating of related art, and the transmittance characteristics in the graph indicate values including back-surface reflection. A thin line of the curves in the graph indicates a designed value of the transmittance characteristics in the antireflection coating obtained by simulation, and a thick line indicates an actual measurement value of the transmittance characteristics in the antireflection coating of an optical element of related art which is actually manufactured. As shown in the graph, the respective transmittance characteristics secure the required transmittance performance of 94.5% or more within an approximate range of incident light wavelength of 450 to 650 nm, for both values of the transmittance characteristics obtained by simulation and actual measurement.

However, the antireflection coating of related art had quite a few negative effects in optical characteristics of the optical element, due to transmittance reduction in an ultraviolet band and an infrared band near the visible light band, when formed to the optical element used in the visible light band. For example, when the optical element like this was used for an optical device such as a camera, a problem of a subtle change in color and the like had occurred.

As shown in the above-described FIG. 8, according to the transmittance characteristics in the antireflection coating of related art, the transmittance at a wavelength of 400 nm is less than 94.5% for both the designed values and the actual measurement values, and the transmittance at a wavelength of 700 nm is less than 94.5% for the actual measurement values.

Further, the optical element formed with the antireflection coating of related art generates variations in transmitted light quantity in the optical elements when mass-produced, which results in a problem that the optical characteristics of the optical-related devices change depending on an individual optical element. Having investigated the data of the optical characteristics of the optical elements formed with the antireflection coating of related art when mass-produced, an approximate difference of 0.66% was generated between the maxim transmittance and the minimum transmittance in the visible light band in average.

FIGS. 9a and 9b are diagrams showing variations in the transmittance characteristics of the antireflection coating of related art. The transmittance characteristics shown in the graph in FIG. 9a are actual measurement values of the optical elements when mass-produced. Nine optical elements having large variations in the transmittance characteristics are extracted, and the transmittance characteristics are shown overlapping with each other. The transmittance characteristics are the values including back-surface reflection.

The chart shown in FIG. 9b indicates the concrete values of variations in the transmittance characteristics of the extracted nine optical elements. The concrete values indicate transmittance band deviations subtracting the minimum value of transmittance from the maximum value of transmittance in a range of wavelength band of 420 to 680 nm. As shown in the chart, an average value of the transmittance band deviation was approximately 0.66%.

### SUMMARY

An advantage of the present invention is to solve the above-described problems, and provides a broadband antireflection coating which further broadens the bandwidth of antireflection coating and reduces variations in transmittance characteristics of the antireflection coating when optical elements are mass-produced.

The broadband antireflection coating according to the present invention includes: is formed on at least one of an incident surface or an emission surface of an optical element and reduces reflected-light quantity of incident light or emission light, and includes a structure laminated with seven layers of thin films.

Further, the broadband antireflection coating according to the present invention, on the surface of the optical element, includes the seven layers of laminated films are alternatively laminated with a thin film using a low refractive index material and a thin film using a high refractive index material.

As mentioned as above, by alternatively laminating seven layers of thin films using the low refractive index material and the high refractive index material, the broadband antireflection coating can broaden the bandwidth of the antireflection coating and reduce variations in the transmittance characteristics of the antireflection coating. When this broadband antireflection coating is formed, for example, on an optical element forming an optical device such as a camera, a subtle change in color can be improved. Further, as the broadband antireflection coating reduces the reduction of transmittance in the ultraviolet band and the infrared band near the visible light band, it is effective in preventing flare and enables to suppress the occurrence of reflection ghost resulting from multiple-reflection from the antireflection coating.

Furthermore, as the broadband antireflection coating reduces variations in the transmittance characteristics, when an optical element formed with the broadband antireflection coating is used for an optical-related device, the optical characteristics of the optical-related device stabilize, and able to improve a performance of the optical-related device.

The broadband antireflection coating according to the present invention, on the surface of the optical element, is formed by sequentially laminating a first thin film having MgF₂ as a material with a thickness of about 37.7 nm; a second thin film having H₄ (a mixture of La and TiO₂) as a material with a thickness of about 6.5 nm; a third thin film having MgF₂ as a material with a thickness of about 122.5 nm; a fourth thin film having H₄ as a material with a thickness of about 13.0 nm; a fifth thin film having MgF₂ as a material with a thickness of about 37.7 nm; a sixth thin film having H₄ as a material with a thickness of about 130.0 nm; and a seventh thin film having MgF₂ as a material with a thickness of about 84.8 nm.

Further, the broadband antireflection coating according to the present invention, on the surface of the optical element, is formed by sequentially laminating a first thin film having MgF₂ as a material with a thickness of about 37.7 nm; a second thin film having OH₅ (a mixture of ZrO₂ and TiO₂) as a material with a thickness of about 6.3 nm; a third thin film having MgF₂ as a material with a thickness of about 122.5 nm; a fourth thin film having OH₅ as a material with a thickness of about 12.6 nm; a fifth thin film having MgF₂ as a material with a thickness of about 37.7 nm; a sixth thin film having OH₅ as a material with a thickness of about 125.6 nm; and a seventh thin film having MgF₂ as a material with a thickness of about 84.8 nm.

### BRIEF DESCRIPTION OF THE DRAWINGS

The invention will be described with reference to the accompanying drawings, wherein like numbers reference like elements.

FIG. 1 is a block diagram showing a first embodiment of a broadband antireflection coating according to the present invention.

FIG. 2 is a chart showing a configuration of the broadband antireflection coating in the first embodiment.

FIG. 3 is a block diagram showing a second embodiment of the broadband antireflection coating according to the present invention.

FIG. 4 is a chart showing a configuration of the broadband antireflection coating in the second embodiment.

FIG. 5 is a graph showing transmittance characteristics of a broadband antireflection coating.

FIGS. 6a and 6b are diagrams showing variations in the transmittance characteristics of a broadband antireflection coating.

FIG. 7 is a diagram showing a configuration example of an antireflection coating of related art.

FIG. 8 is a graph showing transmittance characteristics of the antireflection coating of related art.

FIGS. 9a and 9b are diagrams showing variations in the transmittance characteristics of the antireflection coating of related art.

### DESCRIPTION OF EXMEPLARY EMBODIMENTS

Embodiments of the present invention will now be described below with reference to the drawings.

In the emmbodiment, a number of thin film layers forming an antireflection coating laminated on a surface of an optical element is increased, optimum thin film materials are chosen and an optimum thin film thicknesses is set, as a means to broaden the bandwidth of the antireflection coating. By increasing a number of laminated thin film layers, the antireflection coating has properties of broadening the bandwidth of transmittance characteristics and reducing variations in the transmittance characteristics. A balance between the transmittance characteristics of the antireflection coating and the number of laminated thin film layers needs to be kept, as too many layers result in inefficient mass-production and high production cost. In the present invention, after simulation and trial production using designed values, the optimum number of thin film layers of the antireflection coating is set to be seven layers. The antireflection coating is characterized in broadening the bandwidth with seven layers of thin films and reducing variations in transmitted light quantity of the antireflection coating when mass-produced.

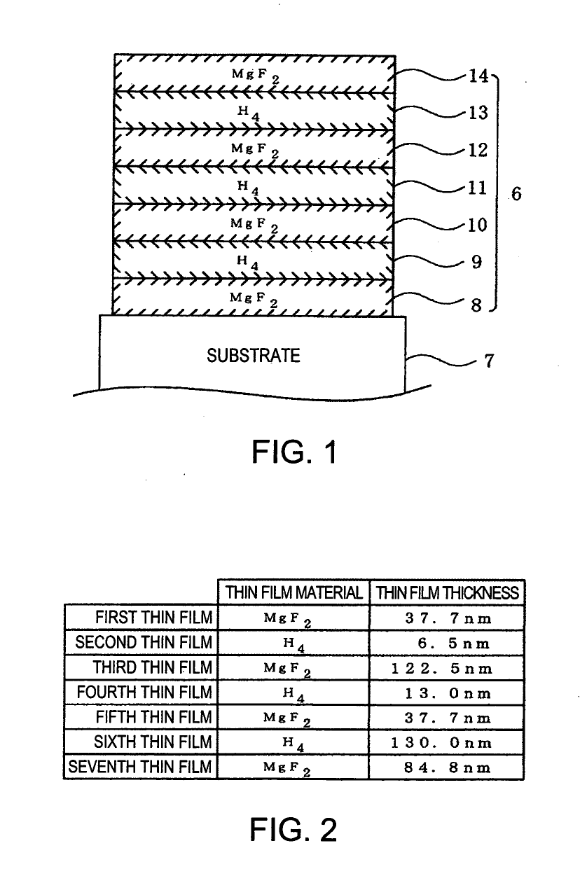

FIG. 1 is a block diagram showing a first embodiment of a broadband antireflection coating according to the present invention. As shown in FIG. 1, a broadband antireflection coating 6 in the first embodiment is formed by laminating seven layers of thin films, and designed to maintain a desired performance over the visible light band, and the ultraviolet band and the infrared band near the visible light band. The broadband antireflection coating 6, on incident and emission surfaces of a substrate 7 which is to become an optical element, is formed by sequentially laminating a first thin film 8, a second thin film 9, a third thin film 10, a fourth thin film 11, a fifth thin film 12, a sixth thin film 13 and a seventh thin film 14. Further, as a material for the first thin film 8 forming the broadband antireflection coating 6, MgF₂ which has a strong adherence to the substrate 7 (especially compatible with a glass substrate) is used. Furthermore, from this onward, the broadband antireflection coating 6 is formed by alternatively laminating six layers of thin films using a high refractive index material and thin films using a low refractive index material, sequentially on a surface of the first thin film 8, from the second thin film 9 to the seventh thin film 14.

In the first embodiment, H₄ ( a mixture of La and TiO₂) which has a refractive index of approximately 2.00 is used as the high refractive index material for thin film, and MgF₂ which has a refractive index of approximately 1.38 is used as the low refractive index material for thin film. With that, a material for the second thin film 9 is to be H₄, a material for the third thin film 10 is to be MgF₂, a material for the fourth thin film 11 is to be H₄, a material for the fifth thin film 12 is to be MgF₂, a material for the sixth thin film 13 is to be H₄, and a material for the seventh thin film 14 is to be Mg F₂.

Next, a calculation formula to obtain respective optimum thicknesses of seven thin film layers forming the broadband antireflection coating 6 is to be shown and the concrete values of the thickness is to be described.

When a physical film thickness of each layer is represented as dₘ (m=1, 2, 3, 4, 5, 6, and 7, indicating the position of layer of the thin film), a refractive index of a thin film material is represented as n, and a center wavelength of visible light (520 nm) is represented as λ,

dₘ=λ/4×n . . . (1) is established.

Next, a thickness of each layer was set as follows by multiplying a predetermined coefficient to the physical film thickness so as to obtain desired optical characteristics.

| | |
|---|---|
| Thickness of the first thin film 8 = | 0.4 × d₁ |
| Thickness of the second thin film 9 = | 0.1 × d₂ |
| Thickness of the third thin film 10 = | 1.3 × d₃ |
| Thickness of the fourth thin film 11 = | 0.2 × d₄ |
| Thickness of the fifth thin film 12 = | 0.4 × d₅ |
| Thickness of the sixth thin film 13 = | 2.0 × d₆ |
| Thickness of the seventh thin film 14 = | 0.9 × d₇ |

The thickness of each thin film can be obtained by the following calculations using the above-described formula (1). The refractive index of MgF₂ which is the low refractive index material for thin film is set to be 1.38, and the refractive index of H₄ which is the high refractive index material for thin film is set to be 2.00.

Thickness of the first thin film

8=0.4×d₁=0.4×λ/4×n=0.4×520/4×1.38≈37.7 (nm)

Thickness of the second thin film 9=0.1×d₂=0.1×λ/4×n=0.1×520/4×2.00=6.5 (nm)

Thickness of the third thin film 10=1.3×d₃=1.3×λ/4×n=1.3×520/4×1.38≈122.5 (nm)

Thickness of the fourth thin film 11=0.2×d₄=0.2×λ/4×n=0.2×520/4×2.00=13.0 (nm)

Thickness of the fifth thin film 12=0.4×d₅=0.4×λ/4×n=0.4×520/4×1.38≈37.7 (nm)

Thickness of the sixth thin film 13=2.0×d₆=2.0×λ/4×n=2.0×520/4×2.00=130.0 (nm)

Thickness of the seventh thin film 14=0.9×d₇=0.9×λ/4×n=0.9×520/4×1.38≈84.8 (nm)

A number of thin film layers, a material for each thin film and a thickness of each thin film of the thin film structure of the above-described broadband antireflection coating 6 will be shown in a chart as a whole. FIG. 2 is a chart showing a configuration of the broadband antireflection coating according the first embodiment. As shown in the chart of FIG. 2, the broadband antireflection coating 6 is formed by seven layers of thin films with predetermined materials and predetermined thicknesses.

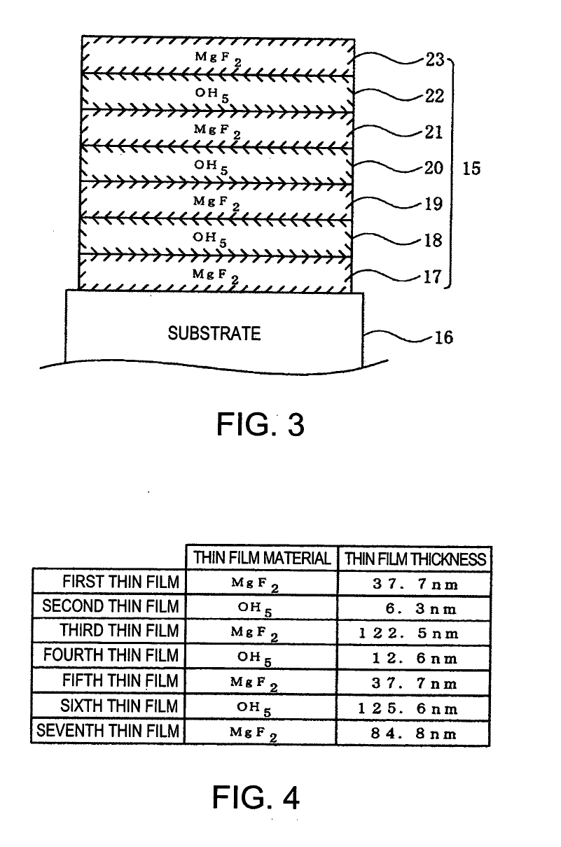

Next, a second embodiment according to the present invention will be described. The second embodiment, having a similar thin film structure to the first embodiment, uses OH₅ (a mixture of ZrO₂ and TiO₂) manufactured by Canon Optron Inc. as a high refractive index material. FIG. 3 is a block diagram showing the second embodiment of the broadband antireflection coating according to the present invention. As shown in FIG. 3, a broadband antireflection coating 15 in the second embodiment is formed by laminating seven layers of thin films, and designed to maintain a desired performance over the visible light band, and the ultraviolet band and the infrared band near the visible light band. The broadband antireflection coating 15, on incident and emission surfaces of a substrate 16 which is to become an optical element, is formed by sequentially laminating a first thin film 17, a second thin film 18, a third thin film 19, a fourth thin film 20, a fifth thin film 21, a sixth thin film 22, and a seventh thin film 23.

And for thin films forming the broadband antireflection coating 15, MgF₂ which is known to have a strong adherence to the substrate 16 (especially compatible with a glass substrate) is used as a thin film material for the first thin film 17. From this onward, the broadband antireflection coating 15 is formed by alternatively laminating six layers of thin films using the high refractive index material and thin films using the low refractive index material, sequentially on a surface of the first thin film 17, from the second thin film 18 to the seventh thin film 23.

In the second embodiment, OH₅ which has a refractive index of approximately 2.07 is used as the high refractive index material for thin film, and MgF₂ which has a refractive index of approximately 1.38 is used as the low refractive index material for thin film. With that, a material for the second thin film 18 is to be OH₅, a material for the third thin film 19 is to be MgF₂, a material for the fourth thin film 20 is to be OH₅, a material for the fifth thin film 21 is to be MgF₂, a material for the sixth thin film 22 is to be OH₅, and a material for the seventh thin film 23 is to be MgF₂.

Next, a calculation formula to obtain respective thicknesses of seven thin film layers forming the broadband antireflection coating 15 is to be shown and the concrete values of the thickness is to be described.

As in a case of the first embodiment, when a physical film thickness of each layer is represented as dₘ (m=1, 2, 3, 4, 5, 6, and 7, indicating the position of layer of the thin film), a refractive index of a thin film material is represented as n, and a center wavelength of visible light (520 nm) is represented as λ,

dₘ=λ/4×n . . . (2) is established.

Next, a thickness of each layer is set as follows by multiplying a predetermined coefficient to the physical film thickness so as to obtain desired optical characteristics.

| | |
|---|---|
| Thickness of the first thin film 17 = | 0.4 × d₁ |
| Thickness of the second thin film 18 = | 0.1 × d₂ |
| Thickness of the third thin film 19 = | 1.3 × d₃ |
| Thickness of the fourth thin film 20 = | 0.2 × d₄ |
| Thickness of the fifth thin film 21 = | 0.4 × d₅ |
| Thickness of the sixth thin film 22 = | 2.0 × d₆ |
| Thickness of the seventh thin film 23 = | 0.9 × d₇ |

The thickness of each thin film can be obtained by the following calculations using the above-described formula (2). The refractive index of MgF₂ which is the low refractive index material for thin film is set to be 1.38, and the refractive index of OH₅ which is the high refractive index material for thin film is set to be 2.07.

Thickness of the first thin film 8=0.4×d₁=0.4×λ/4×n=0.4×520/4×1.38≈37.7 (nm)

Thickness of the second thin film 9=0.1×d₂=0.1×λ/4×n=0.1×520/4×2.07≈6.3 (nm)

Thickness of the third thin film 10=1.3×d₃=1.3×λ/4×n=1.3×520/4×1.38≈122.5 (nm)

Thickness of the fourth thin film 11=0.2×d₄=0.2×λ/4×n=0.2×520/4×2.07≈12.6 (nm)

Thickness of the fifth thin film 12=0.4×d₅=0.4×λ/4×n=0.4×520/4×1.38≈37.7 (nm)

Thickness of the sixth thin film 13=2.0×d₆=2.0×λ/4×n=2.0×520/4×2.07≈125.6 (nm)

Thickness of the seventh film 14=0.9×d₇=0.9×λ/4×n=0.9×520/4×1.38≈84.8 (nm)

A number of thin film layers, a material for each thin film, and a thickness of each thin film of the thin film structure of the above-described broadband antireflection coating 15 will be shown in a chart as a whole. FIG. 4 is a chart showing a configuration of the broadband antireflection coating according to the second embodiment. As shown in the chart of FIG. 4, the broadband antireflection coating 15 is formed by seven layers of thin films with predetermined materials and predetermined thicknesses.

Next, the concrete data of transmittance characteristics in the broadband antireflection coating according to the present embodiment will be described. The following graph and chart of the transmittance characteristics describe characteristics of the broadband antireflection coating of the above-described first embodiment, as an example. Further, the transmittance characteristics of the broadband antireflection coating described in the second embodiment will achieve the same performance.

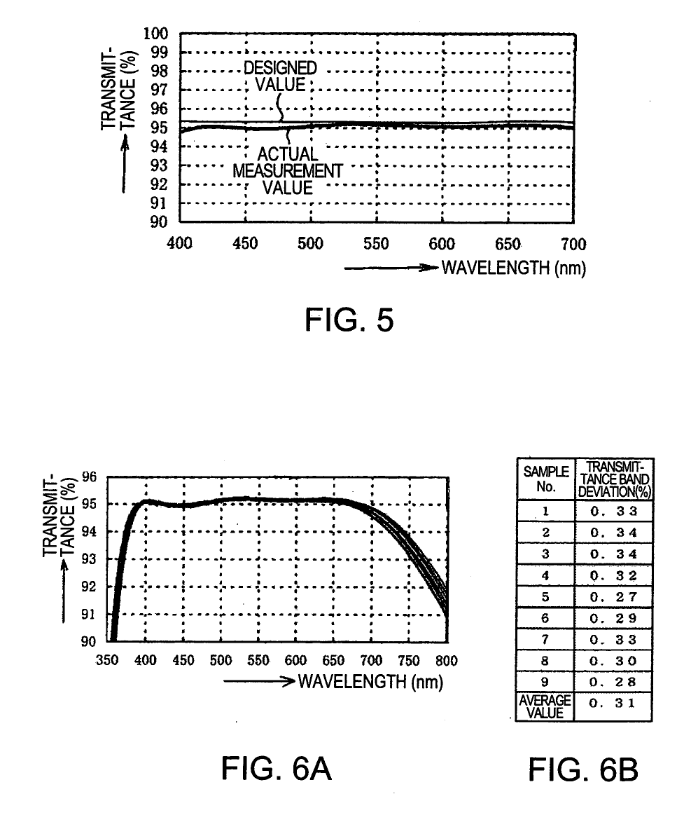

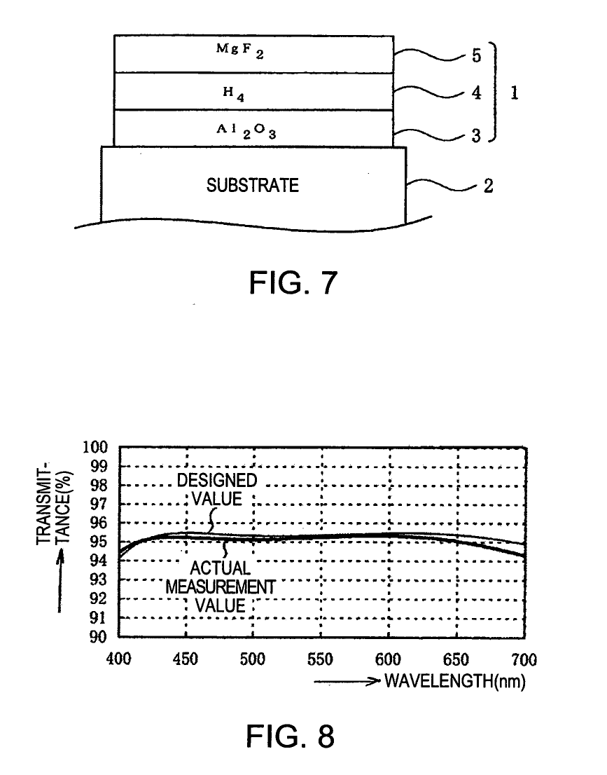

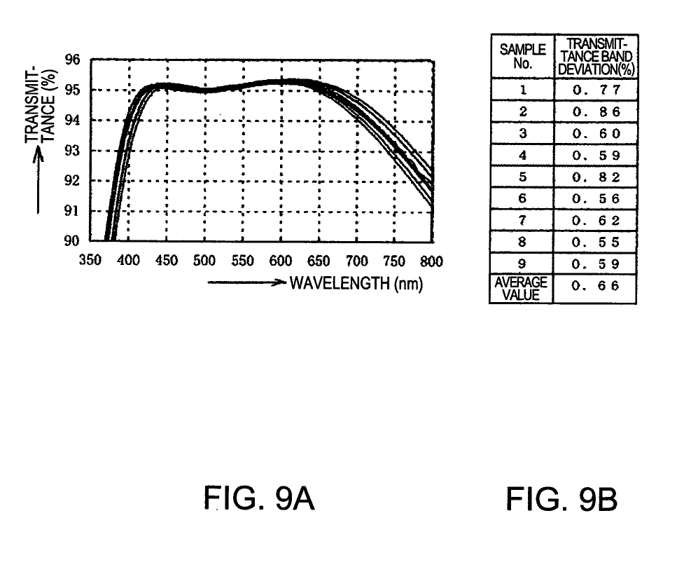

FIG. 5 is a graph showing the transmittance characteristics of the broadband antireflection coating. The transmittance characteristics of the graph shown in FIG. 5 are the values including back-surface reflection, and uses MgF ₂ for the low refractive index material and H ₄ for the high refractive index material. A thin line of the curves in the graph indicates a designed value of the transmittance characteristics of the broadband antireflection coating obtained by simulation, and a thick line indicates an actual measurement value of the transmittance characteristics in the broadband reflection coating of an optical element which is actually manufactured. As shown in the graph, within a range of wavelength from 400 to 700 nm of incident light which satisfies the visible light band, the value of transmittance characteristics obtained by simulation and the value of transmittance characteristics obtained by the actual measurement both secure a required transmittance performance of 94.5% and more. Therefore, the present broadband antireflection coating broadens the bandwidth of the transmittance characteristics compared to the antireflection coating of related art, and reduces the reduction of transmittance in the ultraviolet band and the infrared band near the visible light band.

The difference in transmittance between the value obtained by simulation and the value obtained by actual measurement is the difference that the value obtained by simulation does not include a dispersion value of evaporation materials.

FIG. 6 is a diagram showing variations in the transmittance characteristics of the broadband antireflection coating. The transmittance characteristics in the graph shown in FIG. 6a are the values including back-surface reflection, and MgF ₂ is used for the low refractive index material and H₄ is used for the high refractive index material. Further, the transmittance characteristics are the actual measurement values of an optical element which is actually manufactured, and by extracting nine optical elements having large variations in the transmittance characteristics, the transmittance characteristics are shown overlapping with each other. A chart shown in FIG. 6b indicates the concrete values of variations in the transmittance characteristics of the extracted nine optical elements. The concrete values show transmittance band deviation deducting the minimum value of transmittance from the maximum value of transmittance in the range of wavelength from 420 to 680 nm. As shown in the chart, an average value of the transmittance band deviation is approximately 0.31%. As an average value of the transmittance band deviation, deducting the minimum value of transmittance from the maximum value of transmittance, was approximately 0.66% in the optical element of related art, the variations in the transmittance characteristics of the optical element formed with the broadband antireflection coating of the present invention is remarkably reduced.

As described as above, the optical element formed with the broadband antireflection coating of the present invention, having reduced wavelength dependence and variations in the transmittance characteristics in the visible light band, has a great effect in improving performances of optical-related devices, when the optical element is used for the optical-related devices.

What is claimed is:

1. A broadband antireflection coating formed on at least one of an incident surface or an emission surface of an optical element and reduces reflected-light quantity of incident light or emission light, comprising:
a structure laminating seven layers of a thin film.

2. The broadband antireflection coating according to claim 1, on the surface of the optical element, wherein
the seven layers of laminated films are alternatively laminated with a thin film using a low refractive index material and a thin film using a high refractive index material.

3. The broadband antireflection coating according to claim 1, on the surface of the optical element, wherein
the structure is sequentially laminated with
a first thin film having MgF₂ as a material with a thickness of about 37.7 nm;
a second thin film having H₄ (a mixture of La and TiO₂) as a material with a thickness of about 6.5 nm;
a third thin film having MgF₂ as a material with a thickness of about 122.5 nm;
a fourth thin film having H₄ as a material with a thickness of about 13.0 nm;
a fifth thin film having MgF₂ as a material with a thickness of about 37.7 nm;
a sixth thin film having H₄ as a material with a thickness of about 130.0 nm; and
a seventh thin film having MgF₂ as a material with a thickness of about 84.8 nm.

4. The broadband antireflection coating according to claim 1, on the surface of the optical element, wherein
the structure is sequentially laminated with
a first thin film having MgF₂ as a material with a thickness of about 37.7 nm;
a second thin film having OH₅ (a mixture of ZrO₂ and TiO₂) as a material with a thickness of about 6.3 nm;
a third thin film having MgF₂ as a material with a thickness of about 122.5 nm;
a fourth thin film having OH₅ as a material with a thickness of about 12.6 nm;
a fifth thin film having MgF₂ as a material with a thickness of about 37.7 nm;
a sixth thin film having OH₅ as a material with a thickness of about 125.6 nm; and
a seventh thin film having MgF₂ as a material with a thickness of about 84.8 nm.
